(19) United States
(12) Patent Application Publication
(10) Pub. No.: US 2023/0047265 A1
(43) Pub. Date: Feb. 16, 2023

(54) FAULT TOLERANT DISPLAY

(71) Applicant: ScioTeq bv, Kortrijk (BE)

(72) Inventor: Jürgen Ooghe, Gavere (BE)

(73) Assignee: ScioTeq bv, Kortrijk (BE)

(21) Appl. No.: 17/399,352

(22) Filed: Aug. 11, 2021

(51) Int. Cl. G09G 3/36; G09G 3/00; B64D 43/00

(52) U.S. Cl. CPC G09G 3/3677; G09G 3/006; B64D 43/00; G09G 2330/08; G09G 2330/02; G09G 2310/0286; G09G 2310/0291; G09G 2330/12; G09G 2310/08; G09G 2380/12

(57) ABSTRACT

A fault-tolerant active matrix display device for avionics systems includes a panel glass, a set of source signal lines, and a set of gate signal lines. Each of the gate signal lines includes a first gate line end and a second gate line end on opposite sides of the panel glass. A source driver circuit is coupled to at least a portion of the source signal lines. A first gate driver circuit includes a first set of gate driver cells. Each of the gate driver cells of the first gate line driver circuit includes a gate line output connected to one of the set of gate signal lines at the first gate line end thereof. A second gate driver circuit includes a second set of gate driver cells.

### TECHNICAL FIELD

The present invention relates to an active matrix display device such as a liquid crystal display (LCD) for use in fault-critical systems, where it is important that the display device remains operational, such as in avionics systems.

### BACKGROUND

For safety critical applications the availability and reliability of the equipment is very important. This can be realized in different ways. One solution can be that several copies of the same device are used. For example, an aerospace cockpit system contains several identical displays for redundancy reasons. Recently there is a trend that the displays become larger which reduce the number of displays in a cockpit, hence making it even more important that the display remains operational. This invention aims at a solution to make a large display single fail tolerant so it will be usable in safety critical environments with a high availability.

US patent U.S. Ser. No. 10/056,045B2 discloses an embodiment wherein each horizontal and vertical conductor of a TFT array may be in electrical contact with a first and second control system. Initially, the entire display is driven by the first control system. When/if a failure occurs in the first control system, it is powered down and the second control system maintains operation of the entire display. Each control system may contain a set of source/gate drivers, display interface board, and power supply. A reversionary button may allow the user to manually switch between control systems. Alternatively, failure may be detected by the display interface boards or a graphics processor. This approach of complete redundancy may be very expensive and not always suitable for large screens. Indeed, it would seem that one of the control systems is always offline and is thus not used efficiently.

US patent application US20180226042A1 discloses fault-tolerant liquid crystal displays delineated for avionics systems. At least some example embodiments are methods including providing an avionics display full screen on the LCD, the providing being implemented by driving source signal lines of the LCD by way of a first source driver circuit through a first set of FETs; driving gate signal lines of the LCD by way of a first gate driver circuit through a second set of FETs; preventing back biasing of a second source driver circuit by electrically isolating the source signal lines from the second source driver circuit; and preventing back biasing of a second gate driver circuit by electrically isolating the gate signal lines from the second gate driver circuit. The electrically isolating of the gate signal lines is hereby achieved by way of sets of FETs coupled between driver and signal lines. Hereby, the FETs are additional elements in the display which make the display more expensive and more difficult to produce. Furthermore, the FETs are additional electronical elements coupled in between the essential elements of the display, and can break down and cause problems for a proper functioning of the display. Hence, although the use of FETs to increase fault-tolerance of the display, the presence of the FETs themselves may actually increase the probability of a breakdown of the display.

### SUMMARY OF THE INVENTION

The present invention relates to a fault-tolerant active matrix display device for avionics systems comprising:
a panel glass, a set of source signal lines, and a set of gate signal lines, each of the gate signal lines comprising a first gate line end and a second gate line end on opposite sides of the panel glass;
a source driver circuit coupled to at least a portion of the source signal lines,
a first gate driver circuit comprising a first set of gate driver cells, each of the gate driver cells of the first gate line driver circuit comprising a gate line output connected to one of the set of gate signal lines at the first gate line end thereof;
a second gate driver circuit comprising a second set of gate driver cells, each of the gate driver cells of the second gate line driver circuit comprising a gate line output connected to one of the set of gate signal lines at the second gate line end thereof,

wherein the first gate driver circuit and the second gate driver circuit are configured to drive the gate signal lines collaboratively, and

wherein the first gate driver circuit is configured, upon a failure in the second gate driver circuit, to induce a floating state in the gate line output of each gate driver cell of the second gate driver circuit, and

wherein the second gate driver circuit is configured, upon failure in the first gate driver circuit, to induce a floating state in the gate line output of each gate driver cell of the first gate driver circuit.

The main principle behind the invention is to allow one of the gate driver circuits taking over for the other in case of a failure in the other gate driver circuit, while allowing both gate driver circuits to be used during normal operation, i.e. operation of the display device when no failure has occurred in the gate driver circuits. Furthermore, in case of failure of one of the gate driver circuits, all gate signal lines can still be driven. This is in contrast with prior art devices which:
introduce a redundant gate driver which is not operational during normal operation of the display device, which seems to be a waste of resources since then the redundant gate driver is not working when no failure occurs, which is basically 99% of the time or more; or
introduce a second gate driver which drives different gate lines than the first gate driver, which means that upon failure, the resolution of the display device is typically halved.

### BRIEF DESCRIPTION OF THE FIGURES

FIG. 1 illustrates a prior art active matrix display device.

FIG. 2 illustrates a liquid crystal display in accordance to an embodiment of the present invention.

FIG. 3 shows an exemplary embodiment of gate driver cells according to an embodiment of the present invention.

FIGS. 4-6 illustrate failure modes in gate driver cells according to an embodiment of the present invention.

FIGS. 7A-B and 8 illustrate how an STV signal propagates through each of the gate driver circuits in accordance to an embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In what follows, reference will be made to an LCD, which is a preferred embodiment, but the same arguments and features apply for other types of an active matrix display device. Hence, in embodiments of the present invention, the active matrix display device is an LCD, an AMOLED or a microLED.

As indicated above, the present invention relates to a fault-tolerant active matrix display device, such as a liquid crystal display (LCD), for avionics systems comprising:
a panel glass, a set of source signal lines, and a set of gate signal lines, each of the gate signal lines comprising a first gate line end and a second gate line end on opposite sides of the panel glass;

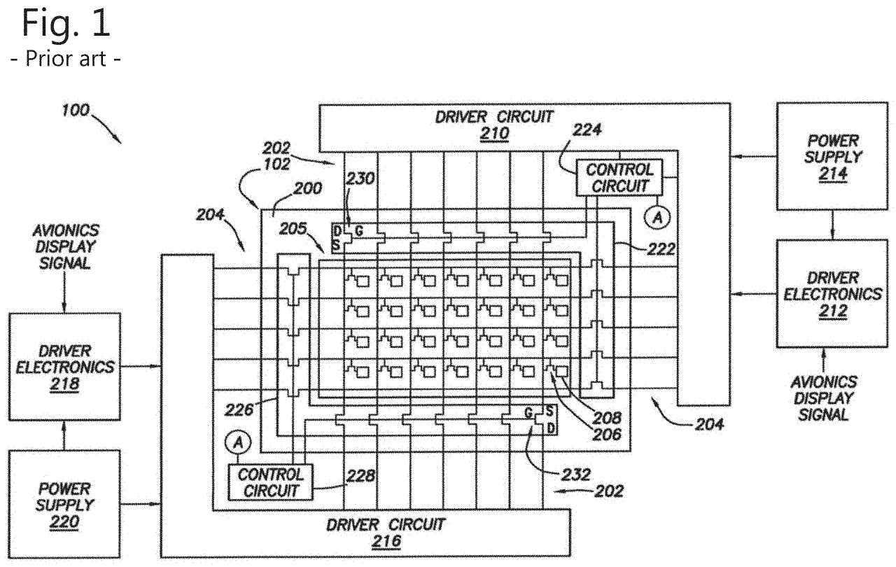

FIG. 1 shows an electrical block diagram of an avionics system as can be found in prior art documents, wherein the general outline of an LCD is illustrated, in particular of its gate signal lines and source signal lines in relation to its glass panel. The example system of FIG. 1 comprises an LCD (102) having panel glass (200), source signal lines (202), and gate signal lines (204). The source signal lines (202) in the example system run vertically through the LCD (102), and the gate signal lines (204) run horizontally, but the orientation may be reversed. LCD (102) may have many hundreds, thousands (or any desired number) of source signal lines and gate signal lines, but the example system shows only seven source signal lines (202) and five gate signal lines (204) so as not to unduly complicate the drawing. At each intersection of a source signal line and a gate signal line within the active area (205) of the panel glass (200) resides a transistor (e.g., transistor (206), lower right pixel) in the form of a field effect transistor (FET), with the gate of the transistor coupled to the gate signal line, and the source of the transistor coupled to the source signal line. The transistor at each intersection couples to a pixel electrode (e.g., pixel electrode (208), lower right pixel) of the overall LCD panel active area. The source signal lines (202), the gate signal lines (204), and the transistors (206) at each intersection within the LCD (102) may all be created using thin film deposition and etching techniques (or any other desired techniques). Thus, the transistors that form the pixels are thin-film transistors (TFT), and for that reason, the LCD (102) may be referred to as a TFT-LCD. The panel glass (200) may take any suitable form, such as a low-temperature amorphous silicon glass substrate, a low-temperature poly-silicon glass created by laser heating of an amorphous silicon glass substrate or any other desired glass substrate.

The example system of the prior art further comprises a driver circuit (210). The driver circuit (210) electrically couples to each of the source signal lines (202) and each of the gate signal lines (204). The driver circuit (210) electrically couples to driver electronics (212) and a power supply (214). The power supply (214) receives input power in any suitable form (e.g., 12 Volts, 24 Volts in avionics systems or any other desired voltage), and converts the power to suitable voltages (e.g., 3.3 Volts or any other desired voltage) for the driver circuit (210) and the driver electronics (212). The driver electronics (212) receives an avionics display signal (e.g., from a master avionics unit, not specifically shown), converts the avionics display signal into appropriate source signals and gate signals, and provides the signals to the driver circuit (210). The driver circuit (210), in turn, drives the source signal lines (202) and gate signal lines (204) to facilitate showing the avionics display (e.g., including the various regions) on the screen area of the LCD (102). Thus, the avionics system (100) may provide an avionics display full screen on the LCD using the driver circuit (210), driver electronics (212), and power supply (214). The prior art system shown in FIG. 1 shows an example avionics system (100) which has full-screen LCD redundancy, having a second driver circuit (216) which is configured to take over driving the source and gate lines in case of failure of the first driver circuit (210).

In the present invention, the LCD comprises a source driver circuit coupled to at least a portion of the source signal lines. The source driver circuit is configured to drive the source signal lines.

Further, in the present invention, the LCD comprises
a first gate driver circuit comprising a first set of gate driver cells, each of the gate driver cells of the first gate line driver circuit comprising a gate line output connected to one of the set of gate signal lines at the first gate line end thereof;
a second gate driver circuit comprising a second set of gate driver cells, each of the gate driver cells of the second gate line driver circuit comprising a gate line output connected to one of the set of gate signal lines at the second gate line end thereof.

wherein the first gate driver circuit and the second gate driver circuit are configured to drive the gate signal lines collaboratively, and wherein the first gate driver circuit is configured, upon a failure in the second gate driver circuit, to induce a floating state in the gate line output of each register cell of the second gate driver circuit, preferably by powering off the second driver circuit, and wherein the second gate driver circuit is configured, upon failure in the first gate driver circuit, to induce a floating state in the gate line output of each register cell of the first gate driver circuit, preferably by powering off the first gate driver circuit.

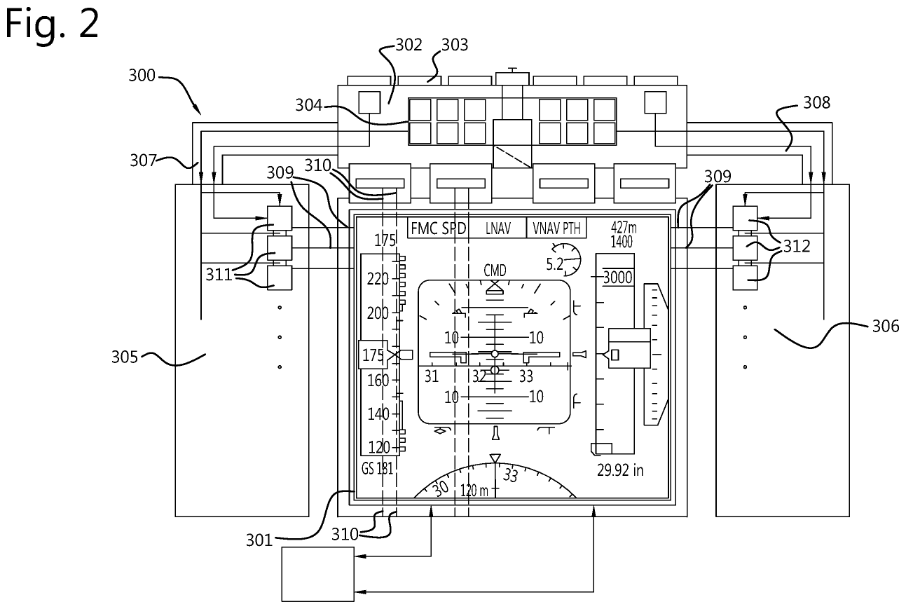

Hence, in the present invention, fault intolerance is increased in a different way as in prior art devices. An embodiment of the present invention is shown in FIG. 2. FIG. 2 shows a liquid crystal display (LCD) (300) comprising a glass panel (301) on which an image can be presented to the user or viewer of the LCD. The LCD comprises a display interface board (DIB) (302) which comprises a video signal input (303) which is configured to receive video signal from e.g. an avionics system. The DIB comprises a source driver circuit (304) which is connected to a set of source signal lines (310) which, in the figure, run in a vertical direction of the glass panel. The LCD also comprises a first gate driver circuit (305) electrically connected (307) to the DIB (302) for receiving first gate driver input signals, and a second gate driver circuit (306) electrically connected (308) to the DIB (302) for receiving second gate driver input signals. The first gate driver circuit is also connected to a set of gate lines (309) on a first side thereof (the left side in the figure), and the second gate driver circuit (306) is connected to the same set of gate lines (309) on a second side thereof (the right side in the figure). Hence, the gate lines form a connection between the first gate driver circuit and the second gate driver circuit.

The first gate driver circuit (305) comprises a set of first gate driver cells (311), and the second gate driver comprises a set of second gate driver cells (312). Each gate line (309) is connected on the first side with a gate line output of a gate driver cell (311) of the set of first gate driver cells and on the second side with a gate line output of a gate driver cell (312) of the set of second gate driver cells. The gate driver cells are configured to drive a gate line of the LCD in function of gate driver cell input signals. In normal operation, i.e. if both the first gate driver circuit and the second gate driver circuit are operational, the gate driver cells connected on either side of the same gate line, cooperate to drive the gate line. If one of the gate drivers fails, the other gate driver is configured to drive the gate lines without the failing gate driver. In order to allow this, each of the gate driver cells is configured to have its gate line output in a floating state in case power to the gate driver cell is turned off.

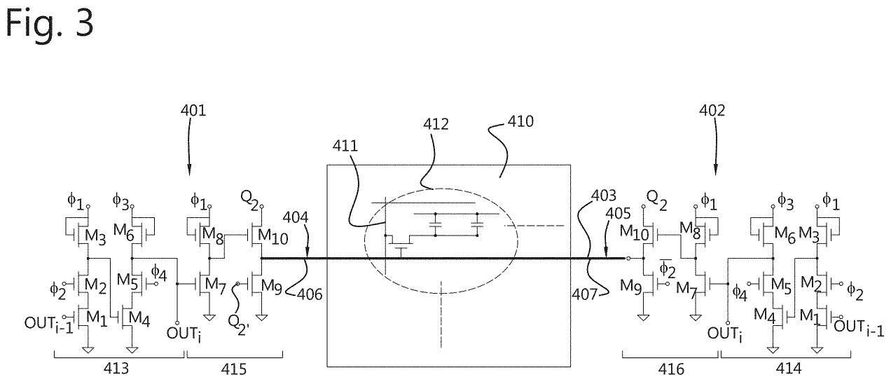

An exemplary embodiment of gate driver cells is illustrated in FIG. 3. A gate driver cell (401) of the first set of gate driver cells is connected via a gate line output (404) to a first end (406) of a gate signal line (403). A gate driver cell (402) of the second set of gate driver cells is connected via a gate line output (405) to a second end (407) of a gate signal line (403). The gate signal line (403) spans across the glass panel (410), where it interacts with the set of source signal lines, one of which (411) being drawn, via an LCD pixel cell (412). In the exemplary embodiment, the gate driver cell (401, 402) comprises a shift register cell (413, 414) and a buffer (415, 416) which comprises the gate line output (404, 405). In normal operation, the first gate driver circuit is configured to send a signal, typically a digital signal, down the first set of gate driver cells, which activates the gate driver cells of the first set one after the other at a clock rate, which typically may depend on the refresh rate and the number of gate lines. Likewise, in normal operation, the second gate driver circuit is configured to send a signal, typically a digital signal, down the second set of gate driver cells, which activates the gate driver cells of the second set one after the other at the same clock rate. The activation of the first and left gate driver cells is synchronized to ensure that the same gate line is driven by both the first and second gate driver cell. Both gate driver cells (401, 402) hereby receive an input (“OUTᵢ₁”) from the gate driver cells connected the previous gate signal line, or from a first gate driver control circuit and a second gate driver control circuit in case the gate signal line is the first of the gate signal lines. The output value of the gate driver cell (“OUTᵢ”) is passed on to the next gate driver cell of the set, and is used to drive the gate line output, in FIG. 3 shown via the buffer (415, 416).

The gate driver cells comprise a set of at least one power input (Q2), which preferably is a DC voltage at a predefined fixed voltage level. The power input allows the gate driver cell to impose a voltage on the gate line output: depending on the output value OUTᵢ of the gate driver cell, the gate line output is set to its value. The power input (Q2) to the gate driver cells of the first set of gate driver cells is preferably a common power input for all gate driver cells of this first set, and/or the power input (Q2) to the gate driver cells of the second set of gate driver cells is preferably a common power input for all gate driver cells of this second set.

In some case, failure of one of the gate driver circuits may occur. In the present invention, each gate driver circuit is configured to power off the power input to the other gate driver circuit in case a failure in the other gate driver circuit occurs. This can preferably be achieved by turning off the power input (Q2) to the gate driver cell of the failing gate driver circuit, preferably each gate driver cell of the failing gate driver circuit, which power input (Q2) powers the gate line output of the gate driver cell of the failing gate driver circuit, preferably of each gate driver cell of the failing gate driver circuit. As a result, the gate signal line is not anymore being driven by the gate driver cells of the failing gate driver circuit. Moreover, the gate line output is hereby in a floating state, such that the gate driver cells of the working gate driver circuit can impose the correct gate signal to the full gate signal line.

Failure Types and Failure Detection

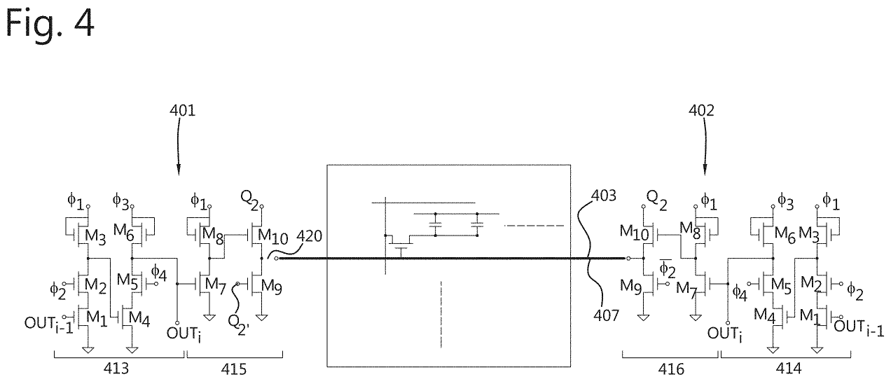

The gate line output of a gate driver cell, and preferably of the buffer thereof, may preferably have three failure modes: “stuck high”, “stuck low” and “open”. They are further described below with references to FIGS. 4-6. The failure modes are described using the embodiment shown in FIG. 3 for the gate driver cells, but they are general failures for essentially all gate driver cells of an LCD.

We note here that FIGS. 4-6 use the embodiment shown in FIG. 3, and that the components in FIGS. 4-6 are essentially the same as indicated in FIG. 3 and discussed in the present description.

In the shown embodiment, the gate driver cell comprises a shift register cell to which an output buffer is connected, which on its turn is connected to the gate signal line via the gate line output. This is the case for each side of the gate signal line. Implementation of the output buffer may exist in multiple configurations. In a preferred embodiment, the gate driver cells, and more preferably the buffers of the gate driver cells, are configured to use three or more levels to drive the gate signal line. Hereby, preferably the gate cell driver, and preferably the buffer thereof, comprises a set of switches such that the gate signal line is connected to relative low impedance sources for high cycle, mid cycle and low cycle signals.

“Open” gate line drive: This is illustrated in FIG. 4. This happens in case of the connection between the gate line output of the gate driver cell, preferably of the buffer thereof, and the gate signal line being open (420). Consequently, no pulse current can be driven through the gate signal line from the gate driver cell on the failing side. This failure can in the present invention be handled because of the redundant connection on the other side (407) of the gate signal line (403) which can drive the gate signal line. Note that the gate line output of the failing gate driver cell is in a floating state independent of the power input (Q2). Furthermore, no pulse current will be present through the push-pull driver on the failing side.

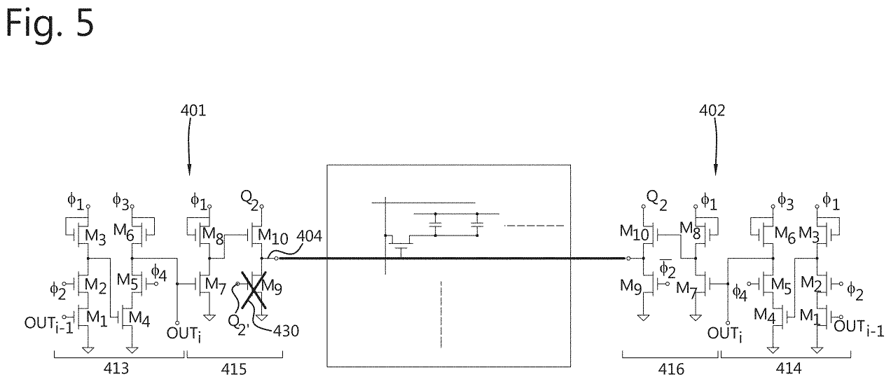

“Stuck low” gate line drive: This is illustrated in FIG. 5. When on one side the bottom transistor (M9) is shorted (430) the current will be significant higher when the power input (Q2) of transistor M10 is on. This can be used as detection signature of the failure mode. The balance of the current between transistor M10 of the first gate driver cell (401) and transistor M10 of the second gate driver cell (402) will give indication of which gate driver cell is failing. There will be difference in balance caused by the gate line resistance. As a result of this detection, the gate driver circuit at the side of the operational gate driver cell can be configured to turn off the power input (Q2) of the gate driver circuit with the failing gate driver cell. Consequently, the gate line output (404) of the failing gate driver cell will be in a floating state.

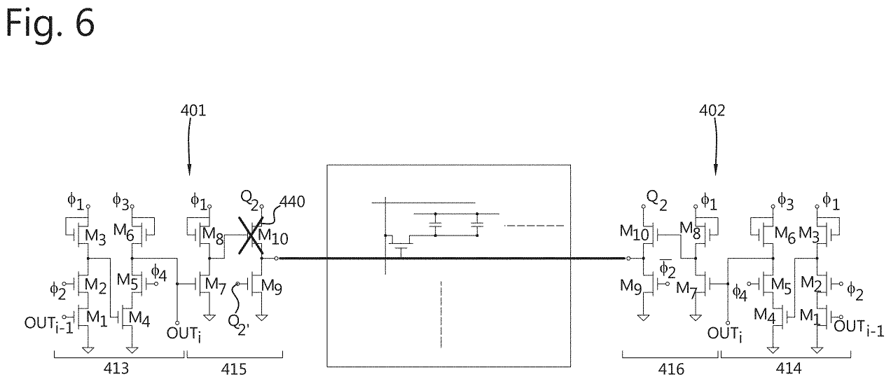

“Stuck high” gate line drive: This is illustrated in FIG. 6. When on one side the top transistor (M10) is shorted (440) the current will be significant higher when the power input (Q2′) of transistor M9 is turned on. This can be used as a detection signature of the failure mode. The balance of the current between transistor M9 of the first gate driver cell (401) and transistor M9 of the second gate driver cell (402) will give indication of which gate driver cell is failing. There will be difference in balance caused by the gate line resistance. As a result of this detection the gate driver circuit at the side of the operational gate driver cell can be configured to turn off the power input (Q2′) of the gate driver circuit with the failing gate driver cell. Consequently, the gate line output (404) of the failing gate driver cell will be in a floating state.

When on one side the top or bottom transistor is open the current will be significant lower on one side and higher on the other side. This can be used as detection signature of the failure mode. The balance of the current between left and right will give indication of which transistor, i.e. of which gate driver circuit, is failing.

Hence, in an embodiment of the present invention, the display device is configured to detect and identify a failing gate driver circuit via a current signature on the gate signal line.

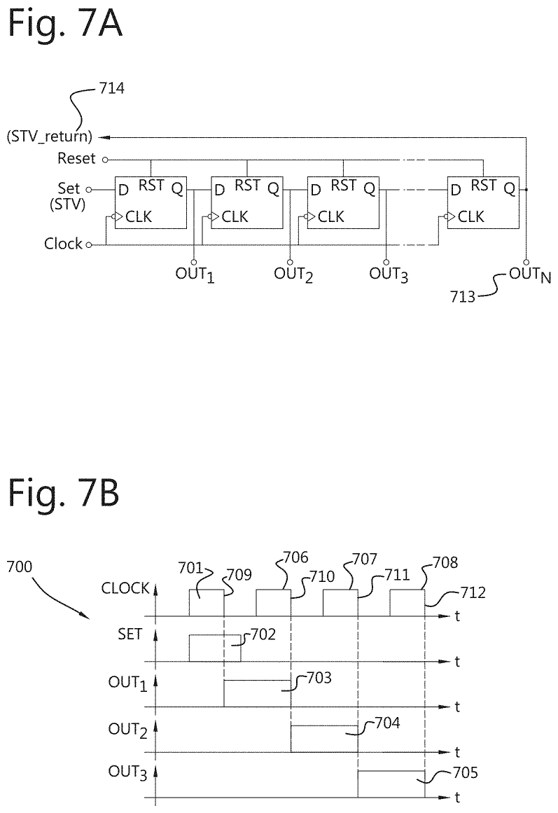

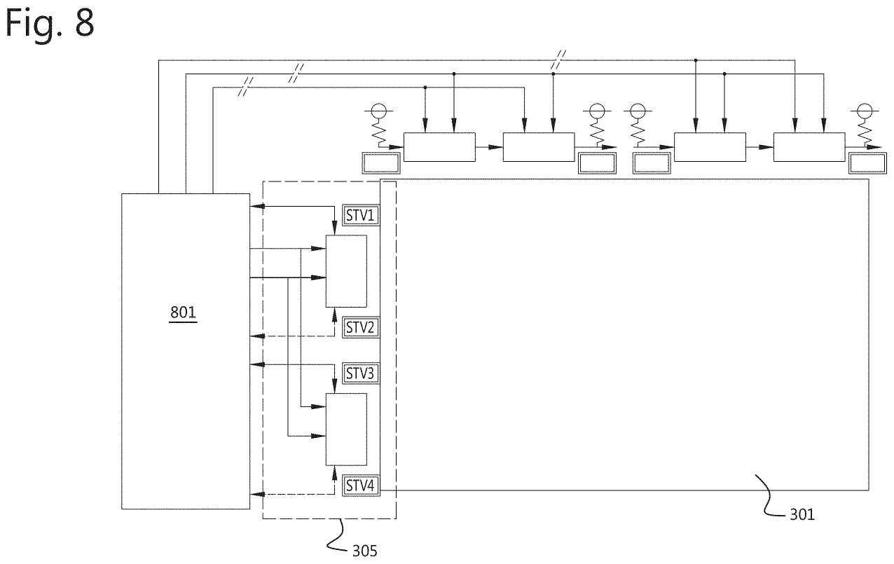

Another way, of detecting failures in the gate driver circuits is by monitoring feedback of a gate driver start pulse vertical (STV) signal. The feedback can preferably be monitored on each gate driver circuit, hence allowing identification of the failing gate driver circuit in case of a failure. Hence, in an embodiment, the display device is configured to monitor feedback of a gate driver STV signal. An STV signal propagates through each of the gate driver circuits as illustrated in FIGS. 7A-B and 8. Preferably, hereby, the display device comprises a display timing controller (TCON) (801) which is configured to generate the STV signal. Note that this display timing controller can preferably also be configured to generate a start pulse horizontal (STH) signal which propagates through the source driver circuit. The STV signal then propagates through each of the gate driver cells as indicated in FIG. 7B:
during a predetermined clock count signal (701), the STV signal (700) is started (‘SET’, 702);
the STV signal arrives at the first gate driver cell (‘OUT1’, ‘STV1’)), preferably at the downwards slope (709) of the predetermined clock count signal (701). This starts a refresh cycle for the first gate line (703), until the second clock count signal (706), preferably until the downwards slope (710) of the second clock count signal (706);
the STV signal then passes to the second gate driver cell (‘OUT2’, ‘STV2’), starting the refresh cycle (704) for the second gate line, until the third clock count signal (707), preferably until the downwards slope of the third clock count signal (711);
the STV signal then passes to the third gate driver cell (‘OUT3’, ‘STV3’), starting the refresh cycle (705) for the third gate line, until the fourth clock count signal (708), preferably until the downwards slope of the fourth clock count signal (712),

and so on for the following gate driver cells of the gate driver circuit, and the corresponding gate lines. This STV signal is propagated synchronously through the first and second set of gate driver cells.

After the STV signal has reached the final gate driver cell (‘OUT _{N}’, 713), the output signal from the final gate driver cell can be fed back and monitored (‘STV return’, 714). If the STV signal has arrived on the final gate driver cell, and thus also on the final gate signal line, after a predefined number of clock counts, then the gate driver circuit and its gate driver cells are functional. If, however, for one of the gate driver circuits, the STV signal has not arrived on the final gate driver cell after the predetermined number of clock counts, that gate driver circuits could be deemed failing.

1. A fault-tolerant active matrix display device for avionics systems, said fault-tolerant active matrix display device comprising:
a panel glass, a set of source signal lines, and a set of gate signal lines, each of the gate signal lines comprising a first gate line end and a second gate line end on opposite sides of the panel glass;
a source driver circuit coupled to at least a portion of the source signal lines,
a first gate line driver circuit comprising a first set of gate driver cells, each of the gate driver cells of the first gate line driver circuit comprising a gate line output driven by a first high-side switch and a first low-side switch connected to one of the set of gate signal lines at the first gate line end thereof;
a second gate line driver circuit comprising a second set of gate driver cells, each of the gate driver cells of the second gate line driver circuit comprising a gate line output driven by a second high-side switch and a second low-side switch connected to one of the set of gate signal lines at the second gate line end thereof,
wherein the first gate line driver circuit and the second gate line driver circuit are configured to drive the gate signal lines collaboratively, and
wherein the first gate line driver circuit is configured, upon a failure in a faulty switch of the second gate line driver circuit, to induce a floating state in the gate line output of each gate driver cell of the second gate line driver circuit, by turning off power supplied to the second high-side switch or the second low-side switch such that the second gate line driver circuit is unable to drive the one of the set of the gate signal lines, and
wherein the second gate line driver circuit is configured, upon failure in the first gate line driver circuit, to induce a floating state in the gate line output of each gate driver cell of the first gate line driver circuit by turning off power supplied to the first high-side switch or the first low-side switch such that the first gate line driver circuit is unable to drive the one of the set of the gate signal lines.

2. (canceled)

3. (canceled)

4. The display device according to claim 1, wherein the gate driver cells each comprise a shift register cell to which an output buffer is connected, which output buffer is connected to the gate signal line via said gate line output.

5. The display device according to claim 4, wherein the output buffer of each gate driver cell is configured to use three or more levels to drive the gate signal line, whereby said output buffer comprises a set of switches such that the gate signal line is connected to different sources for driving the gate signal lines.

6. The display device according to claim 1, wherein the display device is configured to detect and identify a failing gate line driver circuit via a current signature on the gate signal line.

7. The display device according to claim 1, wherein the display device is configured to monitor feedback of a gate driver start pulse vertical (STV) signal.

8. The display device according to claim 7, wherein the display device is configured to detect and identify a failing gate line driver circuit by monitoring feedback of a gate driver start pulse vertical (STV) signal on each of the gate line driver circuits.

9. The display device according to claim 7, wherein the display device is configured to detect a failing gate line driver circuit if, for said gate line driver circuit, the STV signal has not arrived on the final gate driver cell after a predetermined number of clock counts.

10. The display device according to claim 1, wherein the display device comprises a display interface board (DIB) which comprises a video signal input which is configured to receive video signal from an avionics system, wherein the DIB comprises said source driver circuit connected to a set of source signal lines, wherein said first gate line driver circuit is electrically connected to the DIB for receiving first gate driver input signals, and wherein said second gate line driver circuit is electrically connected to the DIB for receiving second gate driver input signals.

11. The display device according to claim 1, wherein the active matrix display device is a liquid crystal device (LCD).
